(19) United States
(12) Patent Application Publication
(10) Pub. No.: US 2004/0237026 A1
(43) Pub. Date: Nov. 25, 2004

(54) System and method for creating reminders in electronic documents

(76) Inventor: Andreas Matthias Aust, Princeton, NJ (US)

Correspondence Address: JOSEPH S. TRIPOLI, THOMSON MULTIMEDIA LICENSING INC., 2 INDEPENDENCE WAY, P.O. BOX 5312, PRINCETON, NJ, 08543-5312, US

(21) Appl. No.: 10/442,292

(22) Filed: May 20, 2003

(51) Int. Cl. G06F 15/00

(52) U.S. Cl. 715/500

(57) ABSTRACT

A user 10 reads an electronic document (ED) 200 stored in a storage 300 using an electronic document reading system (EDRS) 100. A reminder creation system automatically creates reminders for the ED 200 that are subliminally remembered by the user thereby allowing the user to quickly locate particular passages by browsing the document until the reminder corresponding to the particular passage is recognized. The RCS 400 obtains a description of each of one or more areas within ED 200 for which a corresponding reminder is to be created and presented to the user. Next, the RCS 400 obtains the characteristics of each corresponding reminder to be created and presented to the user. Then, the RCS 400 causes the reminder corresponding to each of the one or more areas to be presented to the user each time EDRS 100 presents the respective area to the user.

### FIELD OF THE INVENTION

The invention disclosed herein relates to a system and method for creating reminders or memory aids in electronic documents for readers of the electronic documents.

### BACKGROUND OF THE INVENTION

Even though books, magazines and other documents may be readily available in electronic form, readers often prefer to read such materials in conventional printed form. One reason for this preference is that textual content in electronic form often lacks the memory aids present in a printed document that help a reader remember the locations of passages within the document. For example, in a printed document, each page may have a particular layout that is subliminally remembered by the reader as the document is read so that, later on, the reader can locate particular passages of text by browsing through the document for those pages having layouts that the reader remembers as being associated with the desired text. Various aspects of a printed page's layout may be subliminally remembered by a reader and used to by the reader later on to locate particular passages, including, for example, a picture or other graphic, the particular position on the page of the picture or graphic, folded paper corners, handwritten notes or sketches, or even coffee stains.

In electronic documents, however, text is often presented plainly and without the graphics and other items described above that may serve as memory aids for the reader. This is especially the case where the electronic document is being presented in a memory limited environment, e.g., with a small, handheld electronic device. Consequently, when reading electronic documents without distinctive page layouts, readers often have a greater difficulty in locating particular passages than when reading conventional printed documents.

Some computer programs for working with electronic documents, such as word processing programs and document presentation programs, e.g., Adobe Acrobat® and Adobe Acrobat Reader®, include features designed to assist readers in finding text or particular locations within the document. For example, some of these programs include a highlight feature that allows a reader to use a cursor to select passages of text and then highlight the selected text so that it can be easily found later by browsing through the document. Also, some of these programs include a bookmark function that allows a reader to use a cursor to select a desired location in a document and then insert a bookmark, or placeholder, at that location. After the reader names the bookmark, the bookmark is stored in a list. Later on, the reader can go back to a particular location by calling up the bookmark list and selecting the bookmark corresponding to that location.

An electronic document, such as an HTML page or PDF page, may have graphics provided as an integral part of the document that allow a reader to subliminally remember passages of the document. However, being an integral part of the document, the graphics transmitted as part of the document each time the document is transmitted.

### SUMMARY OF THE INVENTION

The invention provides a method, system, and computer program product for presenting reminders to a user in an electronically presented document. A description of each of one or more areas within the electronic document for which a corresponding reminder is to be created and presented associated with the document is obtained. Next, the characteristics of each corresponding reminder to be created and presented associated with the document are obtained. Then, the reminder corresponding to each of the one or more areas to be presented associated with the document is caused to be presented each time the document is electronically presented.

In accordance with the present invention, reminders are created by the user's device, and these reminders need not, but can be transmitted or stored with the document.

The present invention provides reminders for electronic documents that are subliminally remembered by a user thereby allowing the user to locate previously read passages within an electronic document in much the same manner that the user would locate previously read passages in a conventional paper document. In the preferred embodiment, the invention provides for creating and presenting reminders for an electronic document automatically without any input or intervention by a user (e.g., with only the same manual input required of the user to browse the electronic document, such as the manipulation of scroll up or scroll down buttons).

The invention provides for the reminders to be created and presented according to parameters. In an embodiment of the invention, these parameters are user definable and may be stored in a file that can be shared with other users.

According to the invention, data related to an electronic document is analyzed according to these parameters to determine where, in relation to the document, reminders should appear and what the characteristics of those reminders should be. In an embodiment of the invention, this analysis is performed each time an electronic document is read by the user. In another embodiment, after this analysis is performed, reminder data describing where reminders should appear and the characteristics of those reminders is stored in a file and thereafter, when the user reads the document, rather than performing the aforementioned analysis again, the reminder data is simply retrieved from this file.

In an embodiment of the invention, the reminders are created for an electronic document in real-time as the user browses the document. In another embodiment, all the reminders for an electronic document are created at the same time when the user begins reading the document and thereafter are presented automatically to the user as the document is being read.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 is a block diagram showing the operating environment of an embodiment of the present invention;

FIG. 2 is an example of pages of an electronic document on which reminders are placed in accordance with the present invention;

FIG. 3 is an example of a page of an electronic document on which reminders are placed in accordance with the present invention;

FIG. 4 is an example of pages of an electronic document on which reminders are placed in accordance with the present invention;

FIG. 5 is an example of sections of an electronic document on which reminders are placed in accordance with the present invention;

FIG. 6 is a block diagram showing an embodiment of the present invention;

FIG. 7 is a flow chart showing an operative embodiment of the present invention;

FIG. 8 is a flow chart showing another operative embodiment of the present invention;

FIG. 9 is a flow chart showing another operative embodiment of the present invention; and

FIG. 10 is a flow chart showing another operative embodiment of the present invention.

### DETAILED DESCRIPTION

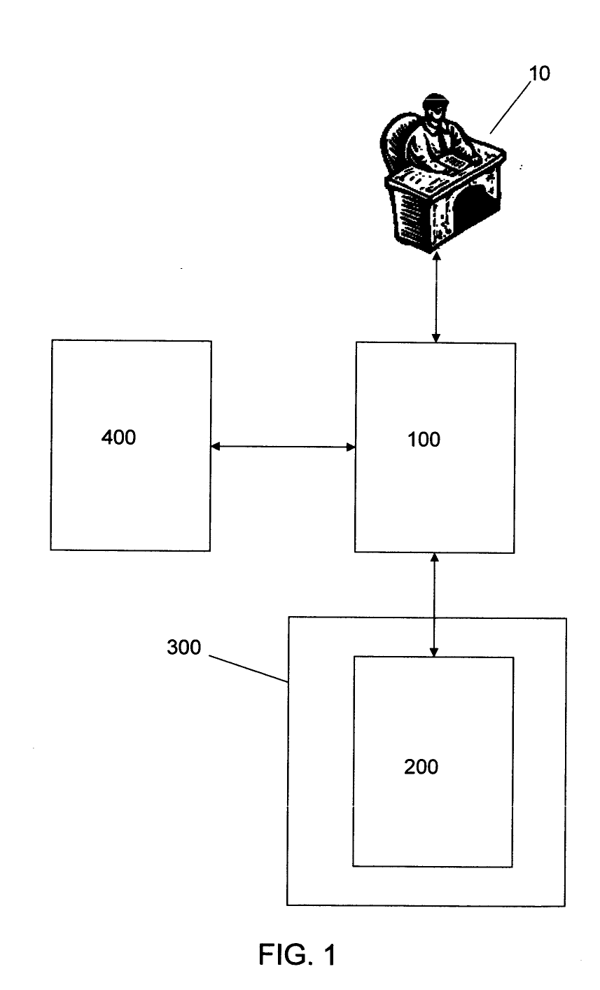

The preferred embodiments of a method, system, and article of manufacture containing software programs in accordance with the present invention is described with reference to the drawings in FIGS. 1-10.

FIG. 1 is a block diagram showing the operating environment of an embodiment of the present invention. A user 10, e.g., a person wishing to read an electronic document, communicates with an Electronic Document Reading (“EDR”) System 100, which may comprise any computer system capable of presenting electronic documents, such as Electronic Document 200, to user 10. For example, EDR System 100 may comprise a personal computer executing a word processing program or a document presentation program such as, Adobe Acrobat® and Adobe Acrobat Reader®. Alternatively, EDR System 100 may comprise, for example, a handheld electronic device with electronic document reader software, such as, an RCA brand Gemstar eBook™ from Thomson Consumer Electronics, Inc.

Electronic Document 200 may comprise any computer readable file containing text that is of a format that is compatible with EDR System 100. For example, Electronic Document 200 may comprise a word processing file, an Adobe® PDF file, a file of the Gemstar eBook format™, or a file of ASCII format. Also, Electronic Document 200 may be stored in a Storage 300 that is accessible to EDR System 100. Storage 300 may comprise any type of persistent data storage such as, for example, a magnetic disk drive, an optical disk drive, or flash memory.

In an embodiment of the present invention, the Reminder Creation (“RC”) System 400 may comprise any computer system capable of automatically creating and presenting reminders, preferably without any manual intervention, that correspond to specific areas of an electronic document such that when an area of the electronic document having a corresponding reminder is presented to a user, the corresponding reminder is also presented to the user.

In a preferred embodiment, the RC System 400 presents the same reminders to a user at the same areas of an electronic document every time the document is presented to the user, and the user can subliminally remember these reminders as the electronic document is read so that, later on, the user can browse through the electronic document until the user recognizes the reminder remembered as corresponding to that passage to locate a particular textual passage of the document

As shown in FIG. 1, RC System 400 is in communication with EDR System 100. As described further below, RC System 400 communicates with EDR System 100 to obtain information regarding Electronic Document 200 and also information regarding the presentation by EDR System 100 of Electronic Document 200 to the user 10. In a preferred embodiment, RC System 400 comprises computer code allowing it to accomplish this communication with EDR System 100.

In a preferred embodiment, RC System 400 also comprises computer code to allow it to create and present reminders to the user. For example, as described below, one type of reminder that may be created and presented by RC System 400 includes computer generated graphics. In that example, RC System 400 comprises computer code allowing it to create computer generated graphics and present those graphics to the user.

In creating and presenting reminders for electronic documents, parameters, which may be referred to as the “Configuration Parameters”, can be used to guide RC System 400 as to (a) which areas of a document are to have reminders, and (b) the characteristics of those reminders.

The Configuration Parameters may specify the areas within an electronic document that are to have corresponding reminders in any manner so long as the same areas are specified, and consequently reminders are presented at the same areas, each time the document is read. For example, the areas may be specified based on the logical structure of the document, such as subparts of the document. For example, the Configuration Parameters may specify that reminders be presented for each paragraph, each sequential group of a certain number of paragraphs, each page, each sequential group of a certain number of pages, each chapter, or each section of a document.

The logical structure of an electronic document may be defined, and consequently ascertained by RC System 400, in a number of ways depending on the format of the document. For example, some electronic document formats, such as word processing documents, may include logical structure data within each document that specifies, based on their logical structure, e.g., each paragraph, page, chapter, or section. For other electronic document formats that do not contain such logical structure data, such as, for example, ASCII formatted documents, logical structure may be determined based on the textual content, e.g., each indentation may indicate a new paragraph, a blank space of two or more lines may indicate a new page, a string of text beginning with a number and a period followed by a blank space of two or more lines may indicate a new section, and a string of underlined text followed by a blank space of two or more lines may indicate a new chapter.

The Configuration Parameters may also specify areas of an electronic document that are to have reminders based on the content of the document in addition to the logical structure. For example, in addition to specifying a subpart of the document, the Configuration Parameters may also specify words or phrases to be searched within the subparts of the document so that all the subparts of the document in which the words or phrases are found will have a corresponding reminder. For instance, the Configuration Parameters may specify a search word and specify the subpart of the document as a page so that each page of the document in which the search word is found will have a corresponding reminder created and presented for it.

As stated above, the Configuration Parameters may also specify the characteristics of the reminders, including, for example, the type of reminders and the appearances of the reminders. With regard to the reminder type, RC System 400 may create and present reminders that comprise any type of computer creatable object that can be perceived by human senses, such as, for example, computer generated graphics, still images (e.g., photographs), animations, motion video, and sound. The characteristics of reminders relates, to how reminders are presented to the user, e.g., color, shape, or type of sound. It should be noted that, as stated above, RC System 400 can comprise computer code enabling it to create and present any or all of these types of reminders to a user.

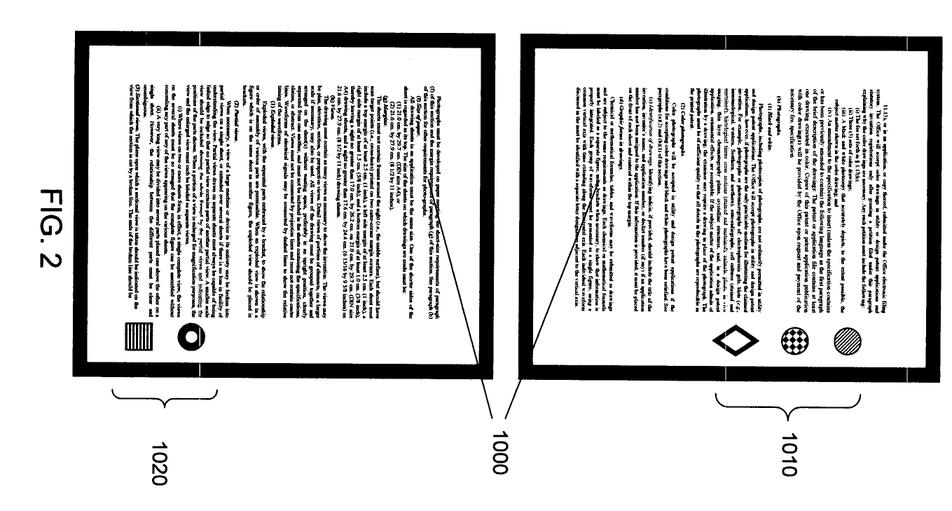

The Configuration Parameters may specify the type and appearance of the reminders in any manner so long as the type and appearance of each reminder is the same each time the document is read. For example, the Configuration Parameters may specify a set of predefined objects (e.g., graphical symbols or sounds) such that the reminders for an electronic document are assigned the appearances of the objects from the set in a sequential manner. For example, FIG. 2 shows two sequential pages 1000 of an electronic document where the Configuration Parameters indicate that reminders should be placed on each page and that the reminders should be assigned sequentially from a set of graphical symbols. Here, the set of graphical symbols includes groups of symbols. For instance, the group of three symbols 1010 and the group of two symbols 1020 each are single members of the set and each represent single reminders with symbol groups 1010 and 1020 being sequential members of the set.

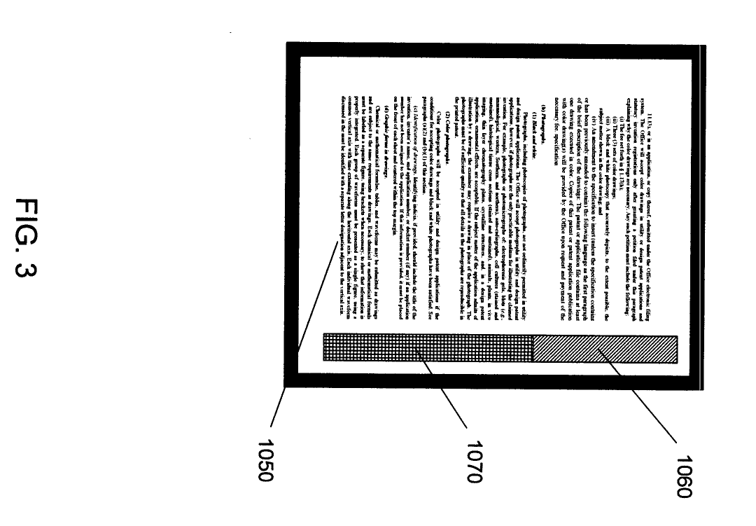

In another example, the Configuration Parameters may specify a predefined shape for the reminders and a predefined set of colors or patterns that are sequentially assigned to reminders. For example, FIG. 3 shows a page 1050 of an electronic document where the Configuration Parameters indicate that reminders should be presented at each group of a certain number of paragraphs and that the reminders be a colored border at the right side of the document having a color from a predefined set, where reminder 1060 is a first color from the set and reminder 1060 corresponds to a first group of paragraphs and reminder 1070 is the next color from the set and reminder 1070 corresponds to a second group of paragraphs that immediately follows the first group.

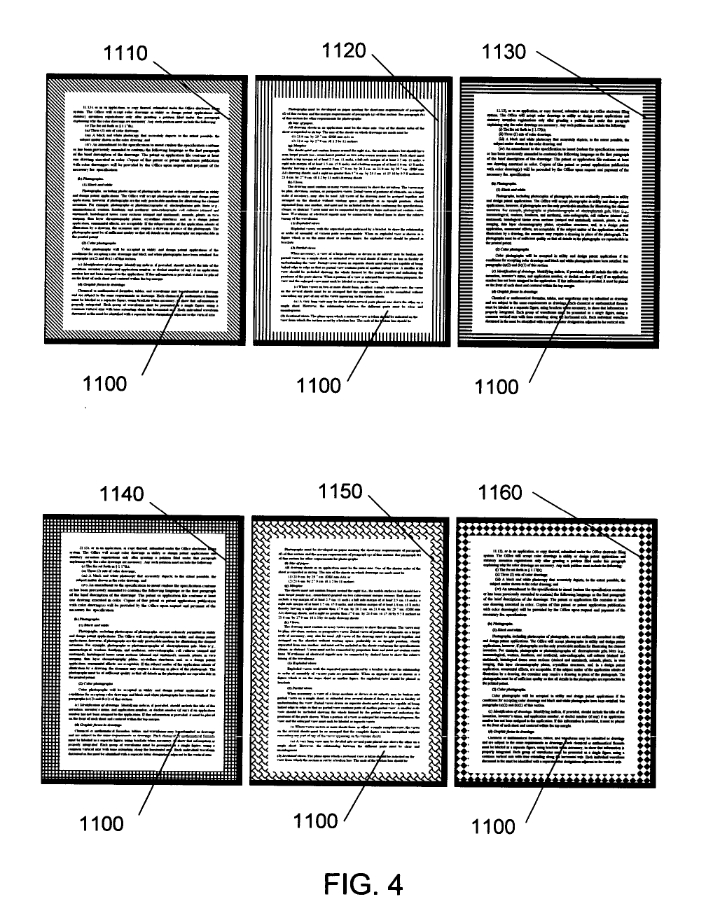

FIG. 4 shows another example of the Configuration Parameters specifying a predefined shape for the reminders and a predefined set of colors or patterns that are sequentially assigned to reminders. FIG. 4 shows pages 1100 which are sequential pages of an electronic document. In FIG. 4, the Configuration Parameters instructing RC System 400 indicate that reminders should be presented at each page and that the reminders be a colored border around each page and have a color from a predefined set. Reminders 1110, 1120, 1130, 1140, 1150, and 1160, which are presented on sequential pages 1100, are sequentially assigned colors from this predefined set of colors.

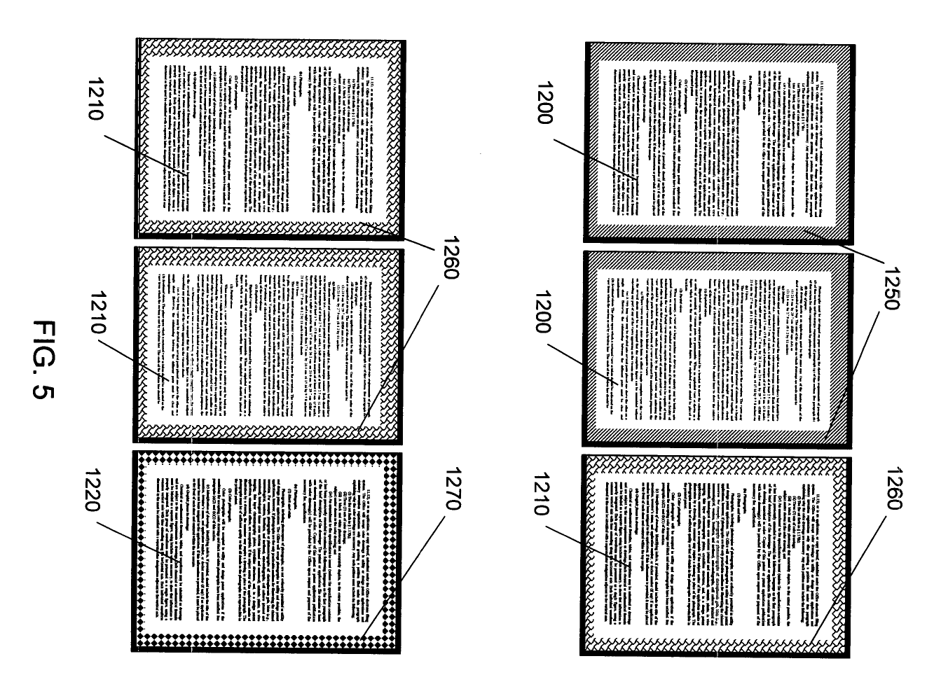

FIG. 5 shows another example of the Configuration Parameters specifying a predefined shape for the reminders and a predefined set of colors or patterns that are sequentially assigned to reminders. FIG. 5 shows three sections 1200, 1210, and 1220 of an electronic document where each section 1200 comprises two pages, section 1210 comprises three pages, and section 1220 comprises one page. In FIG. 5, the Configuration Parameters instructing RC System 400 indicate that reminders should be presented at each section and that the reminders be a colored border around each page of the section and have a color from a predefined set. Reminders 1250, 1260, and 1270, which are presented with sections 1200, 1210, and 1220, are sequentially assigned colors from this predefined set of colors.

Where the areas of an electronic document at which reminders are to be presented are specified based on content as well as logical structure, various reminder appearances may be used. For example, where the Configuration Parameters specify a search word to be found and specify pages as the subparts of the document to be searched, the Configuration Parameters may specify the appearance of the reminders to be highlighting or underlining of the search words found on a particular page. Alternatively, the Configuration Parameters may specify reminders comprising colored borders around each page on which the search word is found.

Graphical symbols may be used as reminders where the areas of an electronic document at which reminders are to be presented are specified based on content as well as logical structure. In the example of FIG. 2, groups of symbols are used as reminders for entire pages. However, it may be desirable, for example, to use single symbols along a border of the page alongside particular paragraphs or sentences to server as reminders for those paragraphs or sentences.

The Configuration Parameters may also specify that the appearance of a reminder is related to the number of times a search word is found within the specified subpart. For example, the Configuration Parameters may specify that if the three or less occurrences of the search word are found in the specified subpart, then the reminder for that subpart may comprise highlighting those occurrences. The Configuration Parameters may also specify that if four or more occurrences of the search word are found in a subpart, then the reminder may comprise a colored border around each page of the subpart.

It should be noted that where the areas of an electronic document at which reminders are to be presented are specified based on content as well as logical structure, more than one set of reminders may be created with each set corresponding to a different search word or phrase. Each set of reminders may also be of a different type and have different appearances. For example, the Configuration Parameters may specify a search word “circuit” to be found within pages of the document with each page on which “circuit” is found having a red border around the page as a reminder. The Configuration Parameters may also specify a search word “transistor” to be found within paragraphs of the document with each paragraph in which “transistor” is found having the same graphical symbol appearing on the right border of the page beside the paragraph.

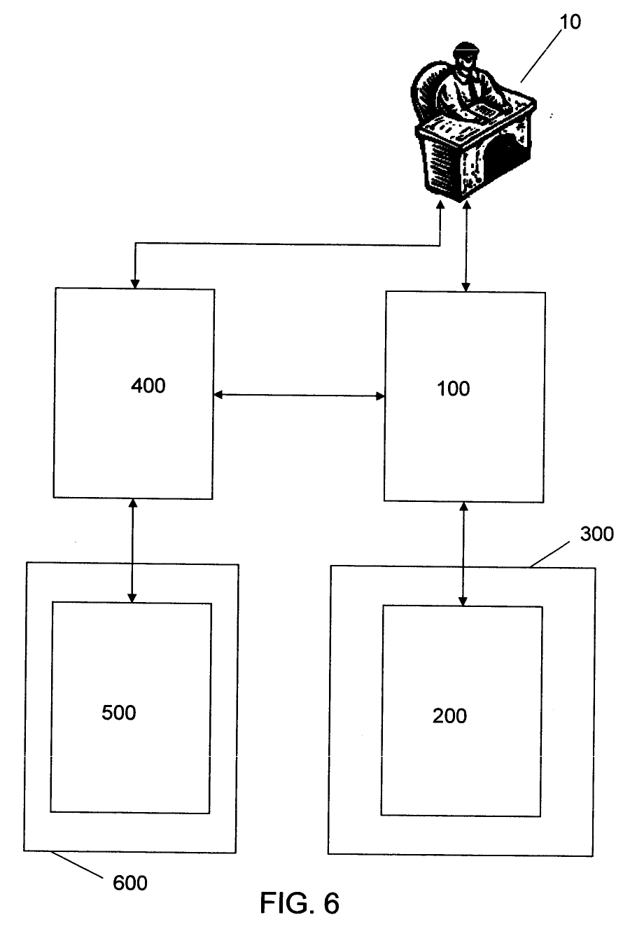

In one embodiment, the Configuration Parameters used to guide RC System 400 in the creation and presentation of reminders are part of the computer code comprising RC System 400. In an alternative embodiment of the invention shown in FIG. 6, the Configuration Parameters are stored in a file 500 contained in a storage 600 to which RC System 400 has access. In this embodiment, user 10 may communicate with RC System 400, such as via a graphical user interface, to modify the Configuration Parameters stored in the file.

Also, where the Configuration Parameters may be stored and retrieved from a file, groups of users may use a common set of Configuration Parameters. For example, Configuration Parameters specifying search words or phrases useful for a particular group of users, e.g., “circuits” and “transistors” for engineers, may be distributed in a file to all the members of the group. In that way, identical reminders will be created and presented to each group member for any electronic document read.

The term “computer system” here is used broadly to mean computer hardware and computer software or computer software only. In FIGS. 1 and 6, EDR System 100, Storage 300, RC System 400, and Storage 600 are shown as distinct systems. However, it should be understood that some or all of EDR System 100, Storage 300, RC System 400, and Storage 600 may be co-resident on the same computer hardware. For example, EDR System 100 may comprise a PC with a word processing or document presentation program and RC System 400 may comprise computer software installed on the same PC as a plug-in to the word processing or document presentation program. In another example, such as where EDR System 100 comprises a handheld electronic device with electronic document reader software, RC System 400 may comprise computer code that is integrated with code of the electronic document reader software.

The RC System 400 and the reminder creation and presentation process of the present invention may be initiated in a number of different circumstances. For example, EDR System 100 may initiate RC System 400 after EDR System 100 receives a request from user 10 to read Electronic Document 200 and loads this document into memory.

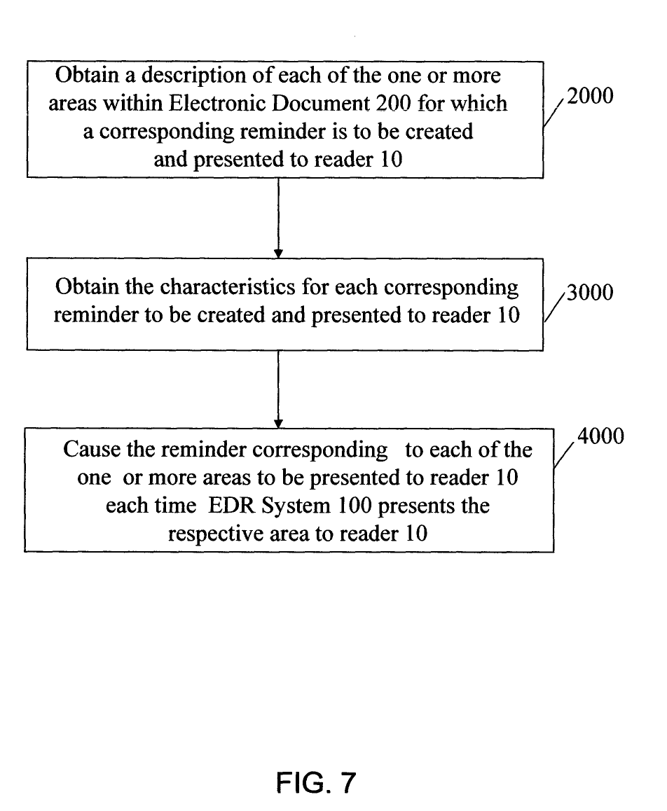

Once initiated, RC System 400 may create and present reminders for an electronic document in a number of ways. FIG. 7 is a flowchart showing the general operation of one way in which reminders may be created and presented to a user by RC System 400. First, as represented by block 2000, RC System 400 obtains a description of each of the one or more areas within Electronic Document 200 for which a corresponding reminder is to be created and presented to user 10. Next, as represented by block 3000, RC System 400 obtains the characteristics for each corresponding reminder to be created and presented to user 10. Then, as represented by block 4000, RC System 400 causes the reminder corresponding to each of the one or more areas to be presented to user 10 each time EDR System 100 presents the respective area to user 10.

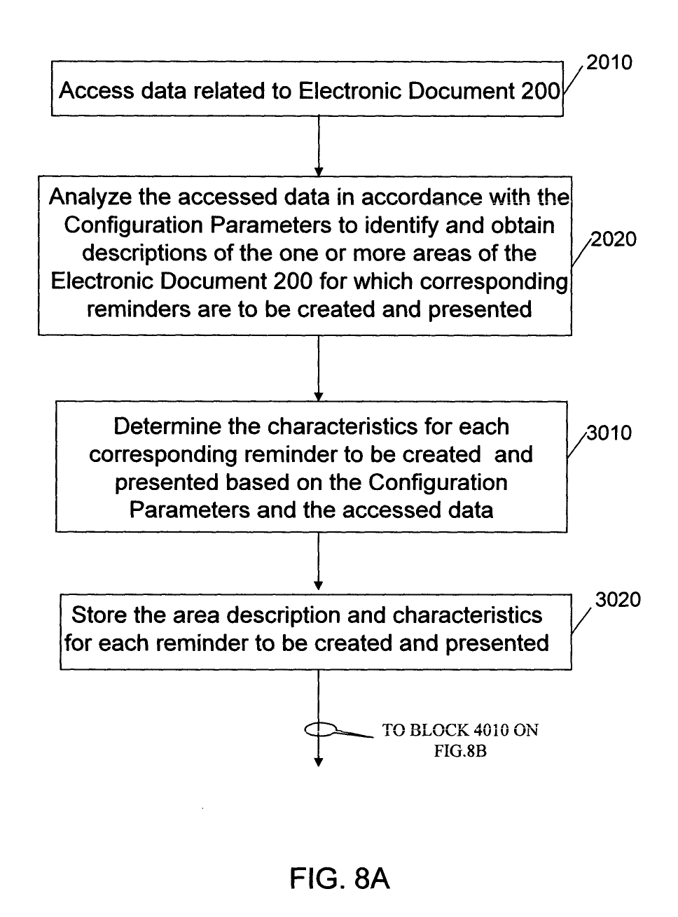

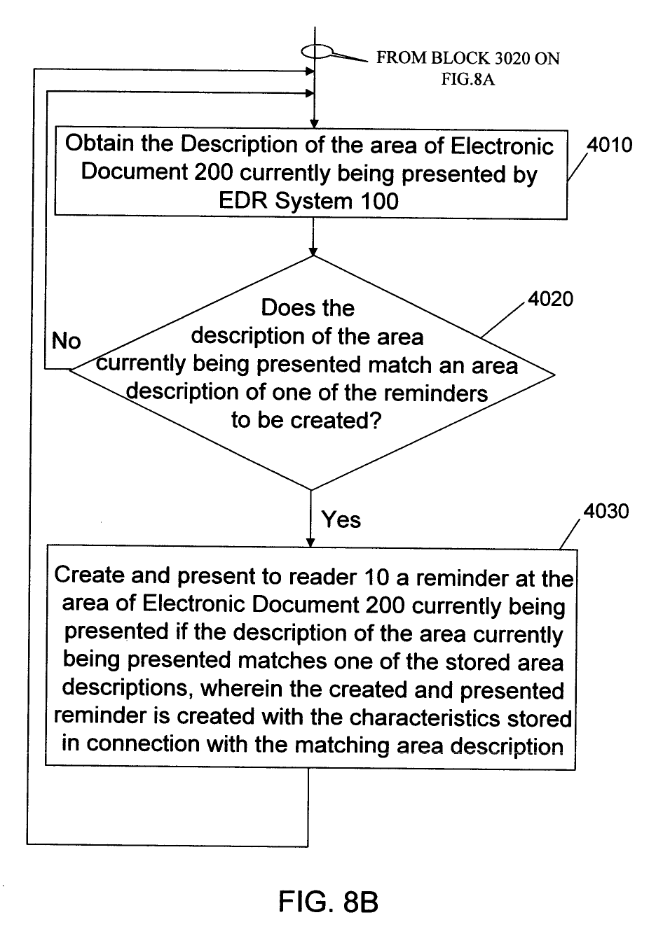

FIG. 8 is a flowchart showing one embodiment of a method of the present invention that accomplishes the operations indicated in the blocks of FIG. 7. In the embodiment of FIG. 8, to obtain a description of each of the one or more areas within Electronic Document 200 for which a corresponding reminder is to be created and presented to user 10, RC System 400 first may communicate with EDR System 100 to access data related to Electronic Document 200, as represented in block 2010. This data may describe the content or logical structure of Electronic Document 200. Next, as represented by block 2020, RC System 400 may analyze this data in accordance with the Configuration Parameters to identify and obtain descriptions of the one or more areas of the Electronic Document 200 for which corresponding reminders are to be created and presented.

As stated previously, the Configuration Parameters may be contained within the computer code for RC System 400 or may be stored in a separate file. Where the Configuration Parameters are stored in a separate file, RC System 400 may retrieve them any time prior to performing the operations represented by block 2020.

The RC System 400 may perform this identification in a number of ways depending upon the Configuration Parameters. For example, where the Configuration Parameters specify the areas of an electronic document for which reminders are to be created and presented based on the logical structure of the document, e.g., by specifying subparts of the document, then RC System 400 may analyze the accessed data related to Electronic Document 200 to identify and thereby obtain descriptions (e.g., beginning and end points) of each specified subpart of the document. For example, where the specified subpart is chapter, then RC System 400 may analyze the accessed data to identify and thereby obtain descriptions of each chapter of Electronic Document 200. Alternatively, where the Configuration Parameters specify the areas of an electronic document for which corresponding reminders are to be created and presented based on the content as well as the logical structure of the document, e.g., by specifying search words or phrases and the subpart of the document to search, then RC System 400 may analyze the accessed data to identify and thereby obtain descriptions of each specified subpart of Electronic Document 200 in which the specified word or phrase is found.

Referring to FIG. 8, to obtain the characteristics for each corresponding reminder to be created and presented to user 10, RC System 400 may determine the characteristics of each corresponding reminder based on the Configuration Parameters and the accessed data, as represented by block 3010. For instance, in the example shown in FIG. 5, the Configuration Parameters explicitly specify several characteristics of the reminders, including that the reminder type is computer generated graphics, and that the reminder appearance is a colored border around each page of the section where the color for the reminders are assigned sequentially from a predefined set of colors. To determine the actual color for each reminder, RC System 400 then assigns colors from the predefined set sequentially to reminders as they are to appear within the Electronic Document 200. Thus, where the predefined set of colors includes blue, red, yellow, and orange, reminders 1250, 1260, and 1270 of sections 1200, 1210, and 1220, respectively, would be assigned the colors blue, red, and yellow.

Returning to FIG. 8, next, as represented by block 3020, RC System 400 stores the area description obtained and the characteristics determined for each reminder to be created and presented for Electronic Document 200. Then, RC System 400 enters into a monitoring loop represented by blocks 4010, 4020 and 4030. While EDR System 100 executes normally, RC System 400 periodically performs the operations represented by blocks 4010, 4020, and 4030 as described below. The time period between cycles of the loops represented by blocks 4010, 4020, and 4030, is a matter of design choice and should be short enough so as to capture any changes in presentation of Electronic Document 200, e.g., user scrolling up or down, user paging up or down, or EDR System 1100 automatically changing the presentation of Electronic Document 200 for any reason.

As represented by block 4010 in FIG. 8, RC System 400 communicates with EDR System 100 to obtain the description of the area of Electronic Document 200 currently being presented by EDR System 100 to user 10. Then, as represented by block 4020, a determination is made as to whether the description of the area currently being presented matches an area description of one of the reminders to be created and presented. If the determination is negative, RC System 400 returns loops and continues monitoring (block 4010) in accordance with a suitable cycle time period.

If the determination in step 4020 is positive, then processing continues with the operations represented by the block 4030, where RC System 400 creates and presents to user 10 a reminder at the area of Electronic Document 200 currently being presented if the description of the area currently being presented matches one of the stored area descriptions, wherein the created and presented reminder is created with the characteristics stored in connection with the matching area description. Then, the method loops, and, in accordance with a suitable cycle time period, repeats the operations represented by block 4010. It should be noted that where the reminder comprises computer generated graphics, RC System 400 creates the reminder as a graphical overlay according to known techniques. Such an overlay appears on top of, but does not interfere with, Electronic Document 200.

In the embodiment of the present invention represented by FIG. 8, RC System 400 creates and presents reminders to user 10 in real-time, e.g., a reminder is created and presented when the user 10 browses an area of Electronic Document 200 for which RC System 400 has previously determined a reminder should be created and presented. Creating and presenting each reminder as necessary may be advantageous in environments where memory is limited, e.g., with handheld electronic devices.

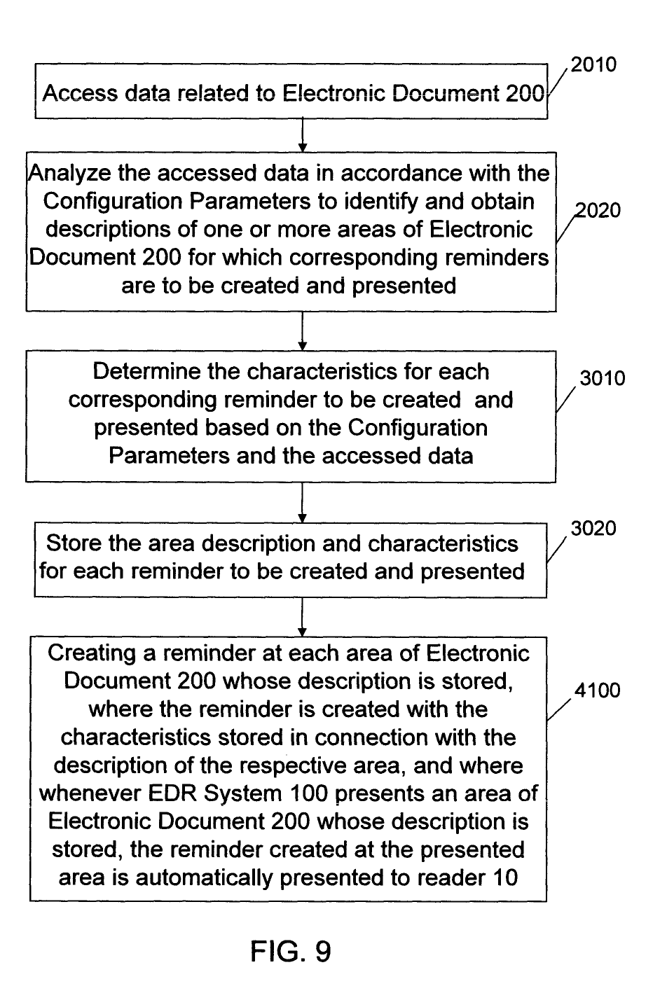

However, it should be noted that RC System 400 may create all reminders at once in a method represented in FIG. 9. In the embodiment of FIG. 9, following block 3020, processing continues with the operations represented by block 4100 where RC System 400 creates a reminder at each area of Electronic Document 200 whose description is stored, where the reminder is created with the characteristics stored in connection with the description of the respective area, and where whenever EDR System 100 presents an area of Electronic Document 200 whose description is stored, the reminder created at the presented area is automatically presented to user 10. For example, where all the reminders to be created comprise computer generated graphics, RC System 400 may create all the reminders at once as a graphics overlay according to known techniques. The overlay is created and resides in memory such that each reminder appears over the area of Electronic Document 200 to which the reminder corresponds automatically whenever that area of Electronic Document 200 is moved into the display window.

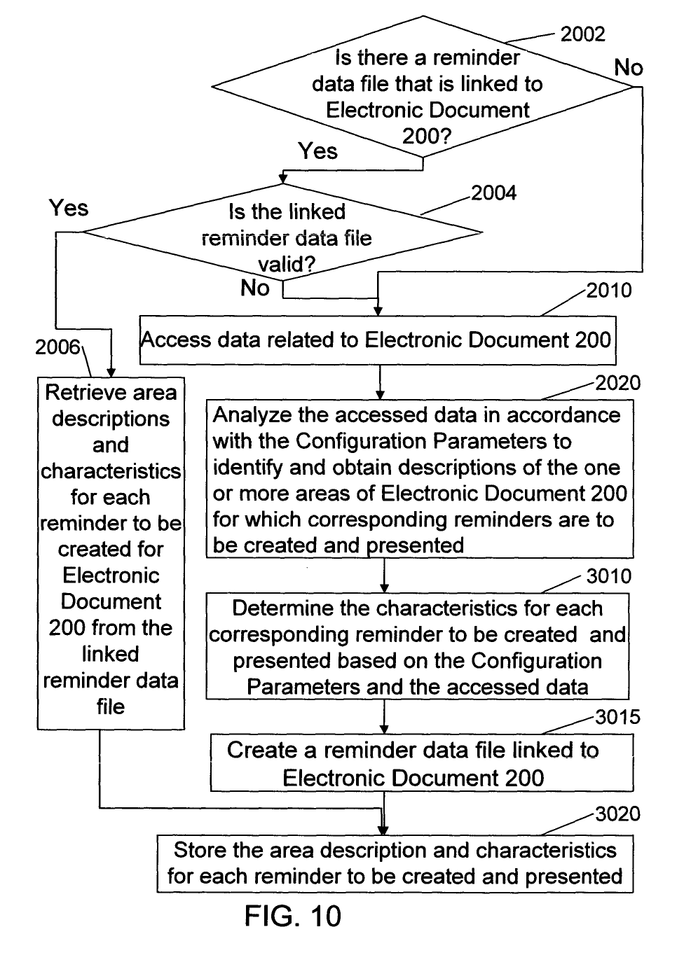

In the embodiments of FIGS. 8 and 9, RC System 400 performs an analysis each time an electronic document is read in order to obtain area descriptions and characteristics for reminders to be created and presented for that document. FIG. 10 is a flowchart of an embodiment of another method of the present invention where RC System 400 may obtain area description and characteristics data from a previously stored file.

First, RC System 400 checks whether a file containing reminder data exists that is linked to Electronic Document 200, as represented by block 2002. Reminder data files may be linked to electronic documents in any manner so as to show a correspondence between a data file and an electronic document. For example, a reminder data file may be linked to an electronic document through a file naming convention, e.g., the reminder data file may have the same filename as the electronic document, but have a different filename extension. If the determination of block 2002 is negative, then processing continues with the operations represented by block 2010.

If the determination of block 2002 is positive, then processing continues with the operations represented by block 2004 where RC System 400 determines whether the linked reminder data file is valid. This validity check is to ensure that the electronic document to which the reminder data file is linked has not changed since the reminder data file has been created. When the reminder data file is created, information is stored therein regarding the electronic document corresponding to the reminder data file to enable this validity check. Such information may include, for example, the date the electronic document was last modified or the file size of the electronic document. If the information stored in the reminder data file does not match the same information from the electronic document currently being read, then the electronic document has been changed since the reminder data file was created and the reminder data file is no longer valid. If the linked reminder data file is no longer valid, processing continues with the operations represented by block 2010. If the linked reminder data file is valid, then processing continues with the operations represented by block 2006 where RC System 400 retrieves area descriptions and characteristics for each reminder to be created for Electronic Document 200 from the linked reminder data file.

As described above, where there is no reminder data file linked to Electronic Document 200 or where the linked data file is no longer valid, processing continues with block 2010. The operations represented by blocks 2010, 2020, and 3010, are performed in the same manner as described above in connection with FIGS. 8 and 9. The area descriptions obtained and characteristics determined for each reminder to be created for Electronic Document 200 are then stored in a newly created reminder data file that is linked to Electronic Document 200, as represented by block 3015.

Following either block 3015 or block 2006, processing continues with the operations represented by block 3020, which are performed in the same manner as described above in connection with FIGS. 8 and 9. Following block 3020, RC System 400 may create and present reminders to user 10 in real-time, as discussed above in connection with FIG. 8, or all at once, as discussed above in connection with FIG. 9.

In addition to creating and presenting reminders automatically as described above, RC System 400 may allow a user to create reminders manually as well. For example, in response to the user activating a predefined user input, e.g., a key or button, RC System 400 may create and present at a predefined subpart currently being viewed a reminder whose characteristics are from a predefined set of reminder characteristics. If the user continues to activate the predefined user input, the reminder's characteristics are changed to the next characteristics from the set.

For example, RC System 400 may have manual reminder creation configuration parameters (“Manual Parameters”) that, in response to the user depressing the “enter” key, provide for RC System 400 to create a reminder and then cycle through the predefined manual reminders. The Manual Parameters may provide, for example, that the predefined subpart is a page and that the predefined reminder appearance is a colored border around the page with the color assigned sequentially from a predefined set of colors. Thus, the first time the user depresses the enter key, RC System 400 may create a colored border around the page currently being presented to the user where the border has the first color from this predefined set of colors. Thereafter, each time the user depresses the enter key while this page is still being viewed, RC System 400 will change the color of the reminder by cycling through the colors of the predefined set.

While the invention has been described and illustrated in connection with preferred embodiments, many variations and modifications as will be evident to those skilled in this art may be made without departing from the spirit and scope of the invention, and the invention is thus not to be limited to the precise details of methodology or construction set forth above as such variations and modification are intended to be included within the scope of the invention.

What is claimed is:

1. a method for presenting reminders associated with an electronic document electronically presented for viewing, the method comprising:
obtaining a description of each of one or more areas within the electronic document for which a corresponding reminder is to be created and presented associated with the document;
obtaining the characteristics of each corresponding reminder to be created and presented associated with the document; and
causing the reminder corresponding to each of the one or more areas to be presented associated with the document each time the document is electronically presented.

2. The method of claim 1, wherein obtaining a description comprises:
accessing data related to the electronic document; and
analyzing the accessed data in accordance with parameters to identify and obtain descriptions of each of the one or more areas.

3. The method of claim 2, wherein obtaining the characteristics comprises determining the characteristics for each corresponding reminder based on the parameters and the accessed data.

4. The method of claim 3, wherein analyzing comprises analyzing the accessed data in accordance with parameters defined by the user.

5. The method of claim 3, further comprising retrieving the parameters from a file prior to the analyzing; and
wherein the analyzing comprises analyzing the accessed data in accordance with the parameters retrieved from the file.

6. The method of claim 3, further comprising storing the area description obtained and the characteristics determined for each corresponding reminder; and
wherein the causing comprises:
obtaining the description of the area of the electronic document currently being electronically presented; and
creating and presenting a reminder at the area of the electronic document currently being electronically presented if the description of the area currently being electronically presented matches one of the stored area descriptions, wherein the created and presented reminder is created with the characteristics stored in connection with the matching area description.

7. The method of claim 3, further comprising storing the area description obtained and the characteristics determined for each corresponding reminder; and
wherein the causing comprises:
creating a reminder at each area of the electronic document whose description is stored, wherein the reminder is created with the characteristics stored in connection with the description of the respective area, and wherein whenever an area of the electronic document whose description is stored is electronically presented, the reminder is automatically electronically presented in association with the presented area.

8. The method of claim 1, wherein obtaining a description comprises retrieving the description of each of the one or more areas from a file; and
wherein obtaining the characteristics comprises retrieving the characteristics of each corresponding reminder from the file.

9. The method of claim 8, further comprising insuring the file is valid prior to retrieving the description and retrieving the characteristics.

10. The method of claim 1, further comprising presenting a different reminder associated with the document in response to receiving a user input.

11. The method of claim 10, further comprising changing the appearance of the different reminder in response to receiving additional user inputs.

12. A system for presenting reminders associated with an electronic document electronically presented for viewing, the system comprising:
means for obtaining a description of each of one or more areas within the electronic document for which a corresponding reminder is to be created and presented associated with the document;
means for obtaining the characteristics of each corresponding reminder to be created and presented associated with the document; and
means for causing the reminder corresponding to each of the one or more areas to be presented associated with the document each time the document is electronically presented.

13. The system of claim 12, wherein the means for obtaining a description comprises:
means for accessing data related to the electronic document; and
means for analyzing the accessed data in accordance with parameters to identify and obtain descriptions of each of the one or more areas.

14. The system of claim 13, wherein the means for obtaining the characteristics comprises means for determining the characteristics for each corresponding reminder based on the parameters and the accessed data.

15. The system of claim 14, wherein the means for analyzing comprises means for analyzing the accessed data in accordance with parameters defined by the user.

16. The system of claim 14, further comprising means for retrieving the parameters from a file; and
wherein the means for analyzing comprises means for analyzing the accessed data in accordance with the parameters retrieved from the file.

17. The system of claim 14, further comprising means for storing the area description obtained and the characteristics determined for each corresponding reminder; and
wherein the means for causing comprises:
means for obtaining the description of the area of the electronic document currently being electronically presented; and
means for creating and presenting a reminder at the area of the electronic document currently being electronically presented if the description of the area currently being electronically presented matches one of the stored area descriptions, wherein the created and presented reminder is created with the characteristics stored in connection with the matching area description.

18. The system of claim 14, further comprising means for storing the area description obtained and the characteristics determined for each corresponding reminder; and
wherein the means for causing comprises:
means for creating a reminder at each area of the electronic document whose description is stored, wherein the reminder is created with the characteristics stored in connection with the description of the respective area, and wherein whenever an area of the electronic document whose description is stored is electronically presented, the reminder is automatically electronically presented in association with the presented area.

19. The system of claim 12, wherein the means for obtaining a description comprises means for retrieving the description of each of the one or more areas from a file; and
wherein the means for obtaining the characteristics comprises means for retrieving the characteristics of each corresponding reminder from the file.

20. The system of claim 19, further comprising means for insuring the file is valid.

21. The system of claim 12, further comprising means for presenting a different reminder associated with the document in response to receiving a user input.

22. The system of claim 21, further comprising means for changing the appearance of the different reminder in response to receiving additional user inputs.

23. A computer program product comprising a computer usable medium having computer readable code embodied therein, the computer readable code, when executed, causing a computer to implement a method for presenting reminders associated with an electronic document electronically presented for viewing, the method comprising:
obtaining a description of each of one or more areas within the electronic document for which a corresponding reminder is to be created and presented associated with the document;
obtaining the characteristics of each corresponding reminder to be created and presented associated with the document; and
causing the reminder corresponding to each of the one or more areas to be presented associated with the document each time the document is electronically presented.

24. The computer program product of claim 23, wherein, in the implemented method, obtaining a description comprises:
accessing data related to the electronic document; and
analyzing the accessed data in accordance with parameters to identify and obtain descriptions of each of the one or more areas.

25. The computer program product of claim 24, wherein, in the implemented method, obtaining the characteristics comprises determining the characteristics for each corresponding reminder based on the parameters and the accessed data.

26. The computer program product of claim 25, wherein, in the implemented method, analyzing comprises analyzing the accessed data in accordance with parameters defined by the user.

27. The computer program product of claim 25, wherein the implemented method further comprises retrieving the parameters from a file prior to the analyzing; and
wherein, in the implemented method, the analyzing comprises analyzing the accessed data in accordance with the parameters retrieved from the file.

28. The computer program product of claim 25, wherein the implemented method further comprises storing the area description obtained and the characteristics determined for each corresponding reminder; and
wherein, in the implemented method, the causing comprises:
obtaining the description of the area of the electronic document currently being electronically presented; and
creating and presenting a reminder at the area of the electronic document currently being electronically presented if the description of the area currently being electronically presented matches one of the stored area descriptions, wherein the created and presented reminder is created with the characteristics stored in connection with the matching area description.

29. The computer program product of claim 25, wherein the implemented method further comprises storing the area description obtained and the characteristics determined for each corresponding reminder; and
wherein, in the implemented method, the causing comprises:
creating a reminder at each area of the electronic document whose description is stored, wherein the reminder is created with the characteristics stored in connection with the description of the respective area, and wherein whenever an area of the electronic document whose description is stored is electronically presented, the reminder is automatically electronically presented in association with the presented area.

30. The computer program product of claim 23, wherein, in the implemented method, obtaining a description comprises retrieving the description of each of the one or more areas from a file; and
wherein, in the implemented method, obtaining the characteristics comprises retrieving the characteristics of each corresponding reminder from the file.

31. The computer program product of claim 30, wherein the implemented method further comprises insuring the file is valid prior to retrieving the description and retrieving the characteristics.

32. The computer program product of claim 23, wherein the implemented method further comprises presenting a different reminder associated with the document in response to receiving a user input.

33. The computer program product of claim 32, wherein the implemented method further comprises changing the appearance of the different reminder in response to receiving additional user inputs.
